(19) United States
(12) Patent Application Publication
(10) Pub. No.: US 2005/0028720 A1
(43) Pub. Date: Feb. 10, 2005

(54) Pop-up device for deterring an attacking animal such as a bear

(76) Inventors: Adam Warwick Bell, San Francisco, CA (US); Anthony Victor Saunders, London (GB)

Correspondence Address: ADAM BELL, 416 FUNSTON AVENUE, SAN FRANCISCO, CA, 94118, US

(21) Appl. No.: 10/634,719

(22) Filed: Aug. 5, 2003

(51) Int. Cl. A01M 29/00

(52) U.S. Cl. 116/22 A

(57) ABSTRACT

A device carried by the human hiker that comprises a pop-up (preferably inflatable) figure that is large and may be rapidly deployed by the user. The figure is meant to scare away an attacking or aggressive animal such as a bear. The activation of the pop-up figure may be accompanied by noises and/or smells and/or projectiles and/or smoke.

### FIELD OF THE INVENTION

The invention relates to devices and methods for preventing or halting an attack by an animal, such as a bear.

### BACKGROUND

Human beings, such as campers, in the wilderness, are vulnerable during encounters with wild animals, such as bears. Bears have often attacked and killed human beings. Human beings find it difficult to escape from an attacking bear, because bears are much faster and stronger than a human, can climb trees, and can attack with great ferocity and speed.

Although the current disclosure relates mostly to bears, it should be understood that bears are used only as an example, and that the current problem and solution may be applied to many different kinds of animal such as elk, moose, mountain lions, buffalo, hippopotamus, rhino, elephant, boar and other animals that are known to be dangerous to man.

The current solutions to mitigating a bear attack are often inadequate. They consist of making a loud noise, such as by blowing a whistle or by shouting. Another preventative method is for the hiker to wear bells or some other motion activated noise-making device, so that the bear will be alerted to the approach of the human, and therefore avoid an encounter. Another solution is to carry fire-arms.

The current solutions are often inadequate, especially in the case of a wounded or hungry bear which is searching for easy prey. The sound of the approaching hiker, wearing bells or blowing a whistle, will simply, alert the bear that a meal is approaching, thus increasing the probability of an attack. Fire-arms are inherently dangerous, undesirable to many never be able to appear significantly larger than the bear. The human will therefore be attacked and possibly killed.

### SUMMARY OF THE INVENTION

The current invention is a device, carried by the human hiker, that comprises a pop-up figure that is large and may be rapidly deployed by the user. The figure is meant to scare away an attacking or aggressive animal such as a bear. The activation of the pop-up figure may be accompanied by noises and/or smells and/or projectiles and/or smoke.

### BRIEF DESCRIPTION OF THE DRAWINGS

FIG. 1 Sequence of events showing (a) a hiker hiking (b) a hiker encountering a bear (c) the hiker activating the device of the invention (d) the bear fleeing in terror.

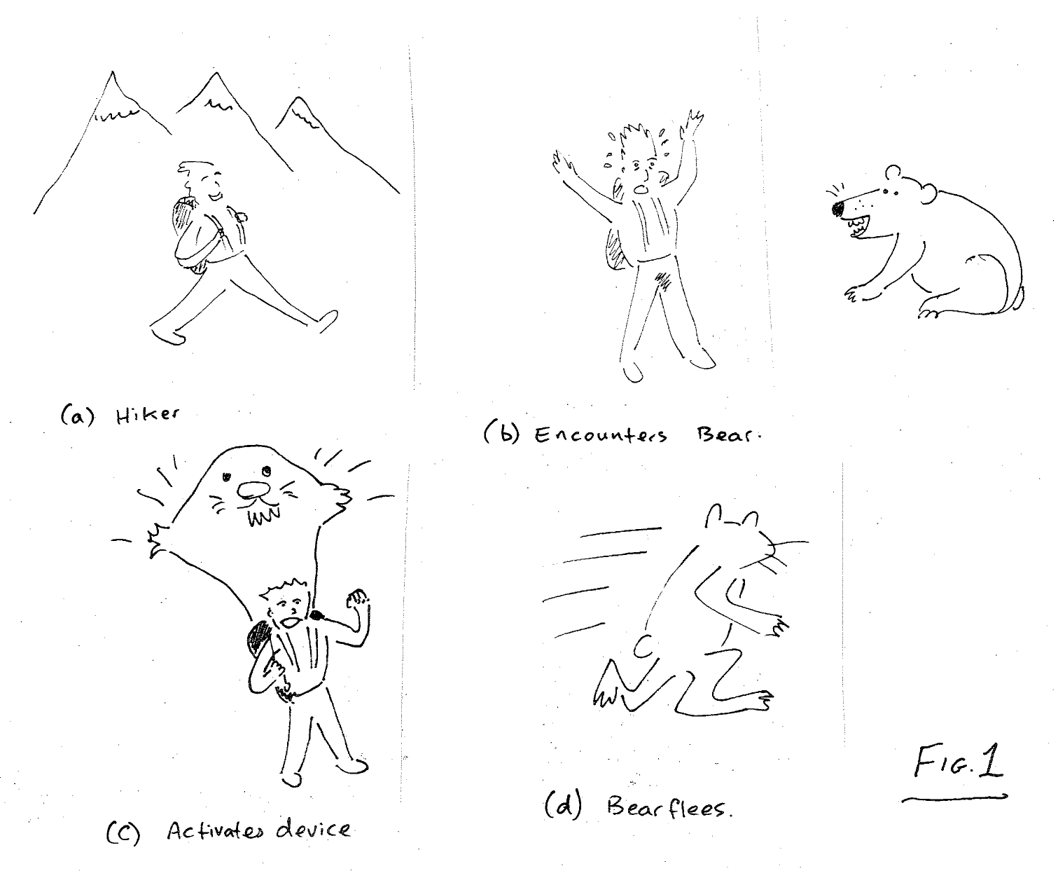

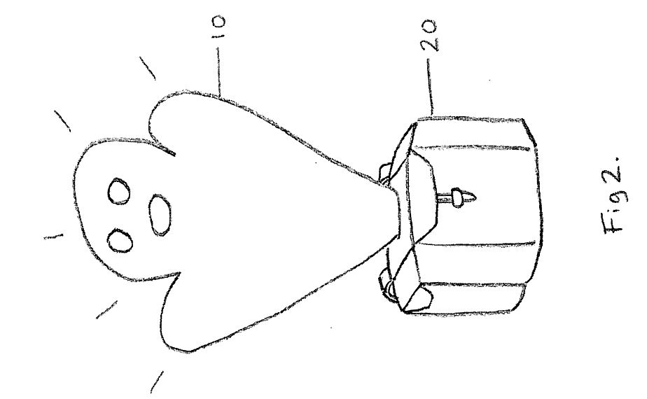

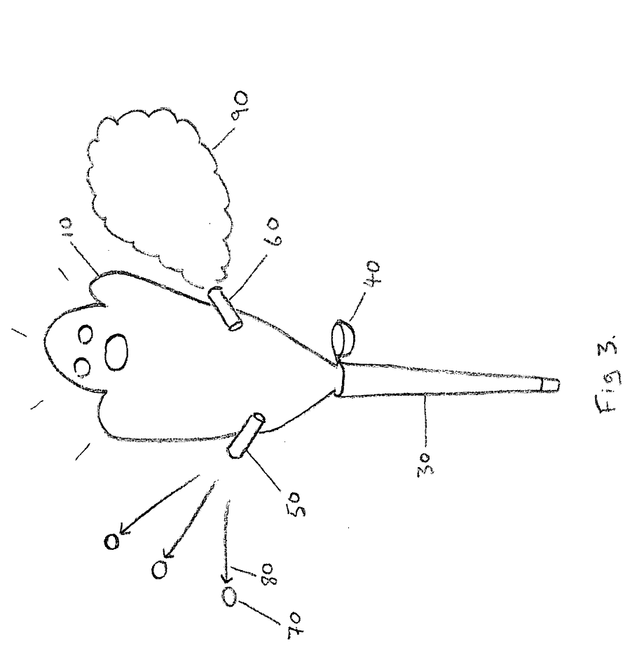

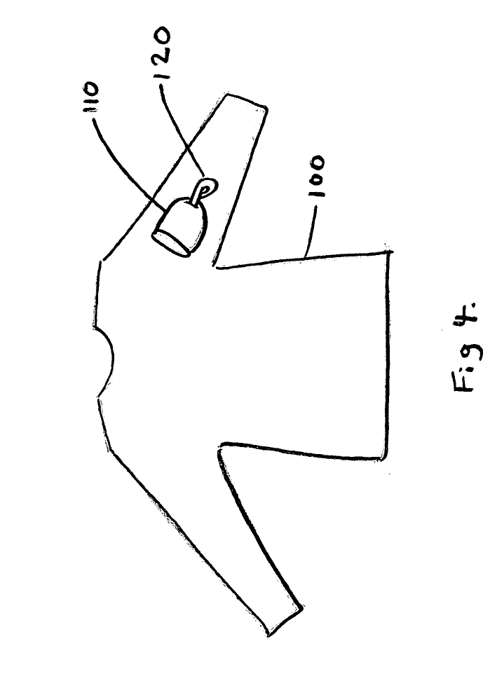

### DETAILED DESCRIPTION OF THE INVENTION

The Invention works on the principle of maximizing the apparent size and ferocity of the human, intimidating the bear (or other animal) and making it retreat from an encounter it fears losing.

The Invention Generally

The current invention, in its simplest form, is a portable device, carried by a hiker, that comprises a pop-up figure that is small when carried prior to deployment, but large when deployed, and may be rapidly deployed by the user. The activation of the figure may be accompanied by noises and/or smells and/or projectiles and/or smoke.

The Invention Using an Inflatable Shell

In one embodiment the pop-up figure of the device may be formed from a molded and shaped inflatable shell, made, for example of rubber or a plastic or a polymer or of any other suitable material.

An inflatable shell that forms the figure may be quickly inflated by filling the shell with a gas released from a pressurized gas container (such as is used to inflate a life-vest). The inflation may be started, for example, by pulling on a chord that opens a valve on the container, releasing the gas into the shell.

Inflation should be very rapid, for example, the figure should be fully inflated within less than 1 minute, or within less than 30 seconds or preferably within less than 10 seconds or most preferably within less than 5 seconds.

The pop-up figure of the device may have the appearance, by virtue of shape, colour, graphic design, sound and/or smell, of a large aggressive animal such as a bear. The figure may easily be made of a plastic shell that has limbs such as arms raised in the classic attacking bear posture. A design of an aggressive bear, teeth bared, claws extended and nostrils flared, may be displayed on the plastic inflatable shell to make it more convincing to a bear.

The pop-up device may be carried by the hiker in any convenient manner. It may be carried as a self-contained unit that could be placed in a back-pack or side pocket of a knapsack for easy access, or carried in the hand. The device may be incorporated into clothing or luggage or a any carried item.

In one embodiment, the device may be incorporated into the hilt of a walking-stick.

In one preferred embodiment the pop-up device could be incorporated into a knapsack, for example in the top part of the knapsack where a pouch or “camel-back” is customarily placed. In this case, when confronted by a bear, the device could be quickly and easily activated by the hiker by pulling a cord. The figure would inflate and pop up out of the back-pack, presenting the attacking bear with a huge and frightening figure of an opponent, and optionally, concomitantly producing noises and/or smells and/or projectiles and/or smoke.

In one embodiment, the pop-up figure may be separate from the back-pack or detachable from the back-pack and may be left in place, between the human and the bear as the human retreats.

The Invention Including a Simultaneous Noise

The activation of the device may additionally include a simultaneous noise, such as one or more explosive “bangs”, a fog-horn, or a loud roaring sound or a screaming sound meant to frighten, disorientate or startle the attacking bear. Such a sound may easily be produced by well known methods, such as by using a pressurized gas container operable attached to a noise maker. Noise makers commonly comprise some form of shaped aperture over or through which air is forced, such as a reed or a whistle-type aperture. Such noise makers can be designed to make different sounds of various pitches and tones. In the present case, for example, one may chose a noise that resembled a deep and very loud roar, or an ear-splitting claxon.

The Invention Including an Odor

Additionally, the deployment of the device may be accompanied by an odor, such as the odor of a male (or female) bear, or a strong sulphurous or ammoniacal odor. For example, the musky odor of a bear would enhance the credibility of the ruse, and help convince the attacking bear that he is being faced with a very powerful, aggressive and musky opponent. Such odors may be artificially produced through traditional synthetic chemistry (such as ester chemistry) and odors may be made to mimic almost any natural smell. Alternatively, a natural odor, extracted from bear, or skunk or other animal, may be used. The odor may be activated concomitantly with the inflation (or other means of deployment) of the device, and may be stored in a pressurized container (separate from any container used to inflate the device. If a pressurized container is used to store and deliver the odor, it may be separate from or may be the same container as is used to store pressurized gasses that inflate the device.

The Invention Including a Noxious Gas or Liquid

Alternatively a odorous or noxious gas or liquid may be sprayed or otherwise projected at the aggressive bear concomitantly with the activation of the device. A gas or liquid—such as a pepper-spray type liquid or an odorous or noxious gas or liquid, could be sprayed at the threatening animal using a container, such as a pressurized container, optionally using an aiming device, such as a directional nozzle or hose. It is well known how to store gases or pressurized liquids, and how to release them from a container, and how to aim them using a hose or nozzle; various standard methods may be used as part of the invention.

The Invention Including Smoke

Additionally, the deployment of the device may be accompanied by the production of smoke that would confuse, startle or disorientate an aggressive bear or other dangerous animal. Smoke may be produced from a typical “smoke-bomb” type of device, which is a chemical, pyrotechnic composition, which when ignited produces smoke, which may be coloured. The smoke-bomb may be simultaneously activated with the pop-up device using a simple electrical ignition system that passes a current through a wire, heating up the wire and igniting the smoke-bomb. When using a pyrotechnic-type smoke bomb, it may be desirable to minimize the risk of fire by shielding any heat or fire generating element from the environment. This may be done by encapsulating the smoke-bomb in a container or cage such that the smoke is released into the atmosphere, but sparks, fire and heat are not. Alternatively, smoke may be released from a non-pyrotechnic device, such as a pressurized container containing a particulate suspension of a dye. In certain embodiments, the smoke-bomb portion may be detachable from or separate from the pop-up figure, so that it mat be placed between the human and the bear as the human retreats. The smoke-producing device may be combined with a pop-up figure that is also detachable and may be left in place, between the human and the bear as the human retreats.

The Invention Including Projectiles

Additionally, the deployment of the device may be accompanied by the launching of projectiles. Any projectiles may be launched such as plastic darts or coloured balls or confetti, for example, which would further confuse, scare and disorientate the bear. Such projectiles could be launched from a mortar or mortar-type device, essentially comprising a hollow cylinder packed with some sort projectile, and having a charge placed in the bottom end, such that when the charge is discharged, the projectiles are propelled out from the top end. The charge could be a simple explosive or a pressurized gas in a container. This sort of mortar is well known and used, for example, in hand-held and table-top party and novelty items that blow confetti into the air. The discharge of the projectiles could be easily coordinated with the activation of the device and inflation of the figure. The projectile device can be incorporated into the pop-up device or separate or detachable from it.

The invention is not limited by the above examples, which are merely illustrative, but encompasses all reasonable modifications and equivalents.

1. A portable device for deterring an attack by an animal upon a user, wherein the device is easily carried by a single user, the device comprising an inflatable figure that increases rapidly in size upon activation by the user, thereby scaring the animal and deterring the attack upon the user.

2. The device of claim 1 wherein the device is fully detachable from the user.

3. The device of claim 2 wherein the device is detachably associated with an item selected from the group consisting of: a knapsack, an item of luggage, and a walking-stick.

4. The device of claim 3 wherein the device is detachably associated with an item of clothing.

5. The device of claim 3 wherein the inflatable figure comprises a molded and shaped inflatable shell formed from a material selected from the group consisting of: a plastic material, a rubber material and a polymer material, and wherein the figure is inflated by a gas released from a pressurized gas container.

6. The device of claim 3 wherein the device is fully inflated within 5 seconds.

7. The device of claim 2 wherein the device is a self-contained portable unit that can be placed in a back-pack or side pocket of a knapsack for easy access, or carried in the hand.

8. The device of claim 2 wherein activation is accompanied by the production of a loud noise.

9. The device of claim 8 wherein the noise is selected from the group consisting of: an explosion, a horn, a whistle, and a shout.

10. The device of claim 2 wherein activation is accompanied by the production of a smell.

11. The device of claim 10 wherein the smell is a smell similar to that of an animal.

12. The device of claim 2 wherein activation is accompanied by the production of smoke.

13. The device of claim 12 wherein the smoke is produced by a pyrotechnic device.

14. The device of claim 2 wherein activation is accompanied by the launching of one or more projectiles.

15. The device of claim 2 wherein the figure, when inflated is shaped is the form of a bear.

16. A method for deterring an attack by an animal upon a user using the device of claim 1, the method comprising activating the device wherein the device increases rapidly in size, thereby scaring the animal and deterring the attack upon the user.
